(19) United States
(12) Patent Application Publication
(10) Pub. No.: US 2009/0199345 A1
(43) Pub. Date: Aug. 13, 2009

(54) Collapsible Combination Tool for Servicing Firearms and Method of Using the Same

(75) Inventor: Jon Morgan, Jefferson City, MO (US)

Correspondence Address: THOMPSON COBURN LLP, ONE US BANK PLAZA, SUITE 3500, ST LOUIS, MO, 63101, US

(73) Assignee: CJ WEAPONS LLC, Jefferson City, MO (US)

(21) Appl. No.: 12/351,402

(22) Filed: Jan. 9, 2009

Related U.S. Application Data
(60) Provisional application No. 61/020,619, filed on Jan. 11, 2008.

(51) Int. Cl. B25F 1/04; F41C 27/00

(52) U.S. Cl. 7/118; 42/108; 7/138

(57) ABSTRACT

A firearm servicing tool comprises a hinge piece, a fixed size wrench head, and first and second handle portions. The wrench head is attached and fixed in position relative to the hinge piece. Each of the first and second handle portions is pivotally connected to the hinge piece. The handle portions are movable relative to each other and relative to the wrench head in a manner such that the tool can be selectively reconfigured into at least first and second alternative configurations. The first and second handle portions engage each other and surround the wrench head when the tool is in the first configuration. The first and second handle portions engage each other with the wrench head extending outwardly therefrom when the tool is in the second configuration.

### CROSS-REFERENCE TO RELATED APPLICATIONS

This patent application claims priority to provisional patent application Ser. No. 61/020,619, entitled “Collapsible Combination Tool for Servicing Firearms and Method of Using the Same”, filed Jan. 11, 2008, the entire disclosure of which is incorporated herein by reference.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to tools for servicing firearms. More particularly, this invention relates to a collapsible handheld combination tool comprising several implements for servicing firearms.

2. Related Art

Various tools or implements exist for servicing firearms such as the military's M16 and M4 automatic rifles. While such implements are useful in maintaining firearms in proper working order, it can be difficult to maintain a complete set of tools and it can be cumbersome to carry such a set tools in the field.

### SUMMARY OF THE INVENTION

The collapsible combination tool of the present invention and the method of using the same overcomes the disadvantages of tools commonly used for servicing firearms. The tool is compact and contains numerous attached implements that are frequently used to maintain firearms in working condition. A belt pouch comprising a pocket for carrying and releasably storing the tool is preferably provided with the tool.

In one aspect of the invention, a firearm servicing tool comprises a hinge piece, a fixed-size wrench head, and first and second handle portions. The wrench head is attached and fixed in position relative to the hinge piece. Each of the first and second handle portions is pivotally connected to the hinge piece. The handle portions are movable relative to each other and relative to the wrench head in a manner such that the tool can be selectively reconfigured into at least first and second alternative configurations. The first and second handle portions engage each other and surround the wrench head when the tool is in the first configuration. The first and second handle portions engage each other with the wrench head extending outwardly therefrom when the tool is in the second configuration.

In another aspect of the invention, a firearm servicing tool comprises a handled body, a brush implement, and a flexible tether. The handled body comprises first and second handle portions that are movable relative to each other. The handled body also comprises a first connector. The brush implement comprises a second connector. The brush implement is connectable to the handled body by securing the first and second connectors to each other. The flexible tether has opposite ends. One of the ends comprises a third connector and the other of the ends comprises a fourth connector. The brush implement is securable in a movable manner to the handled body via the tether by securing the first and third connectors to each other and the fourth and second connectors to each other.

In yet another aspect of the invention, a method of servicing a firearm comprises utilizing a tool to service the firearm. The firearm comprises a threaded ring. The tool comprises first and second handle portions and a fixed-size wrench head. The first and second handle portions are movable relative to each other and to the wrench head. The utilization of the tool comprises moving the first and second handle portions relative to each other in a manner causing the wrench head to extend outwardly from the first and second handle portions and thereafter using the wrench head to rotate the threaded ring of the firearm.

In still another aspect of the invention, a method involves using a tool to service a firearm. The firearm comprises a barrel having a bore. The tool comprises first and second handle portions, a first connector, a flexible tether, and a brush implement. The first and second handle portions are movable relative to each other. The brush implement comprises a second connector that is initially connected to the first connector in manner attaching the brush implement to the first and second handle portions. The tether comprises third and fourth connectors. The method comprises a step of moving the first and second handle portions of the tool relative to each other in a manner such that the brush implement can be grasped. The method also comprises a step of uncoupling the first and second connectors from each other in a manner disconnecting the brush implement from the first and second handle portions. Furthermore, the method comprises a step of extending the tether through the bore of the barrel of the firearm. Still further, the method comprises a step of coupling the third and first connectors to each other in a manner securing the tether to the first and second handle portions after the step of uncoupling the first and second connectors from each other. The method also comprises a step of coupling the second and fourth connectors to each other in a manner connecting the brush implement to the tether while the tether extends through the bore of the barrel of the firearm. Additionally, the method comprises a step of forcing the first and second handle portions to move away from the barrel of the firearm in a manner causing the tether to pull the brush implement through the bore of the barrel of the firearm.

Further features and advantages of the present invention, as well as the operation of various embodiments of the present invention, are described in detail below with reference to the accompanying drawings.

### BRIEF DESCRIPTION OF THE DRAWINGS

FIG. 1 illustrates a perspective view of a collapsible combination tool in accordance with the invention, and is shown in its collapsed configuration.

FIG. 2 illustrates another perspective view of the tool shown in FIG. 1, as viewed from the opposite side thereof.

FIG. 3 illustrates a view of the hinged end of the tool shown in FIGS. 1 and 2.

FIG. 4 illustrates a view of the tool shown in FIGS. 1-3 with the tool being in an open configuration with several of its implements extended outward.

FIG. 5 illustrates another view of the tool shown in FIGS. 1-4, with the tool being in an open configuration with several of its implements extended outward.

FIG. 6 illustrates another view of the tool shown in FIGS. 1-5, with the tool being in an open configuration with several of its implements extended outward.

FIG. 7 illustrates yet another view of the tool shown in FIGS. 1-6, with the tool being in an open configuration with several of its implements extended outward.

FIG. 8 illustrates a view of the tool shown in FIGS. 1-7, with the tool being in an open configuration with the majority of its implements retracted into the handle portions.

FIG. 9 illustrates a view of the tool shown in FIGS. 1-8, with the tool being in its inverted configuration and the wrench implement extending therefrom.

FIG. 10 illustrates a view of the tool that is similar to the view shown in FIG. 9, showing the opposite side of the tool.

FIG. 11 illustrates a partial view of the tool shown in FIGS. 1-10, showing details of several of the implements of the tool.

FIG. 12 illustrates a partial view similar to that of FIG. 11, showing details of several other implements of the tool.

FIG. 13 illustrates a partial view similar to that of FIG. 12, showing the implements of the tool in different relative positions.

FIG. 14 illustrates a partial view similar to that of FIGS. 12 and 13, with a few of the implements disassembled from the tool.

FIG. 15 illustrates the tether associated with the tool shown in the other figures.

FIG. 16 illustrates the tether shown in FIG. 15, with the rag pulling fitting threadably removed therefrom.

FIG. 17 illustrates the tether being utilized to secure the brush implement to the tool.

FIG. 18 illustrates the belt pouch associated with the tool shown in the other figures.

FIG. 19 is a top view of one of the handle portions of the tool.

FIG. 20 is a side view of one of the handle portions of the tool.

FIG. 21 is a side view of the hinge piece of the tool.

Reference numerals in the written specification and in the drawing figures indicate corresponding items.

### DETAILED DESCRIPTION OF THE PREFERRED EMBODIMENT

A preferred embodiment of firearm servicing tool 100 in accordance with the invention is shown in the drawing figures and comprises first 102 and second 104 handle portions and a hinge piece 106, which are preferably formed of metal such as stainless steel. The first 102 and second 104 handle portions are preferably identical to each other and are preferably formed from extruded c-channel material or folded sheet material. Each of the first 102 and second 104 handle portions has opposite sidewalls 108 that are connected by an intermediate wall 110. The side walls 108 of each of the handle portion are preferably parallel to each other and oriented perpendicular to the intermediate wall 110. A channel 112 is formed between the side walls 108 of each handle portion. Each handle portion preferably has a through-hole 114 extending through its side walls 108 at each of its longitudinal ends. Each handle portion comprises a pair of cuts 116 that separate its intermediate wall 110 from its side walls 108 adjacent one of its longitudinal ends, thereby providing the intermediate wall with a cantilevered portion 118. The cantilevered portion 118 of each intermediate wall 110 preferably slopes toward the nearest through-hole 114 slightly out of plane with respect to the reminder of the intermediate wall.

The hinge piece 106 preferably has a thickness that is more than ten times the thickness of the side 108 and intermediate 110 walls of the handle portions. This provides the hinge piece 106 with an appreciable mass and allows the hinge piece to serve as hammer. The hinge piece 106 comprises a pair of through-holes 120 that are parallel to, and spaced from, each other. A shaft or pivot pin 122 pivotally connects the hinge piece 106 to the first handle portion 102 by extending through one of the through-holes 120 of the hinge piece and through one of the first handle portion's through-holes 114. Similarly, another shaft or pivot pin 122 pivotally connects the hinge piece 106 to the second handle portion 102 by extending through the other one of the through-holes 120 of the hinge piece and through one of the second handle portion's through-holes 114. Each shaft or pivot pins is preferably welded or otherwise fixed to its respective handle portion. The dimensions of the hinge piece 106 are such that the side walls 108 of the first handle portion 102 are able to engage against the side walls 108 of the second handle portion 104, in a flush manner and with the channels 112 of the handle portions facing each other, when the tool 10 is in a first (collapsed) configuration. Additionally, the dimensions of the hinge piece 106 are such that the handle portion are able swing around the hinge piece until their intermediate walls 110 engage each other, in a flush manner and with the channels 112 of the handle portions facing away from each other, when the tool 10 is in a second (inverted) configuration.

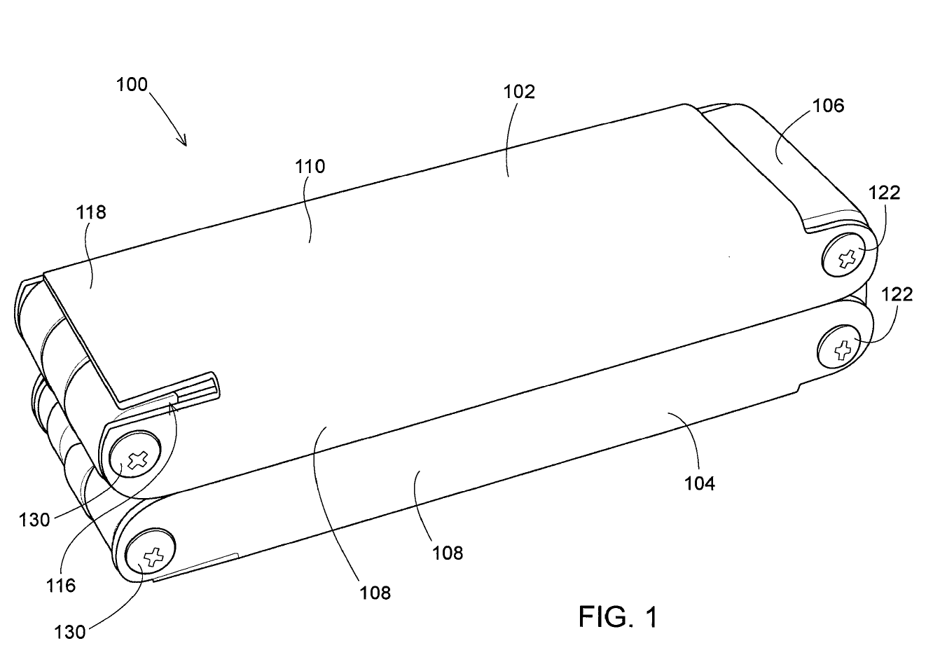

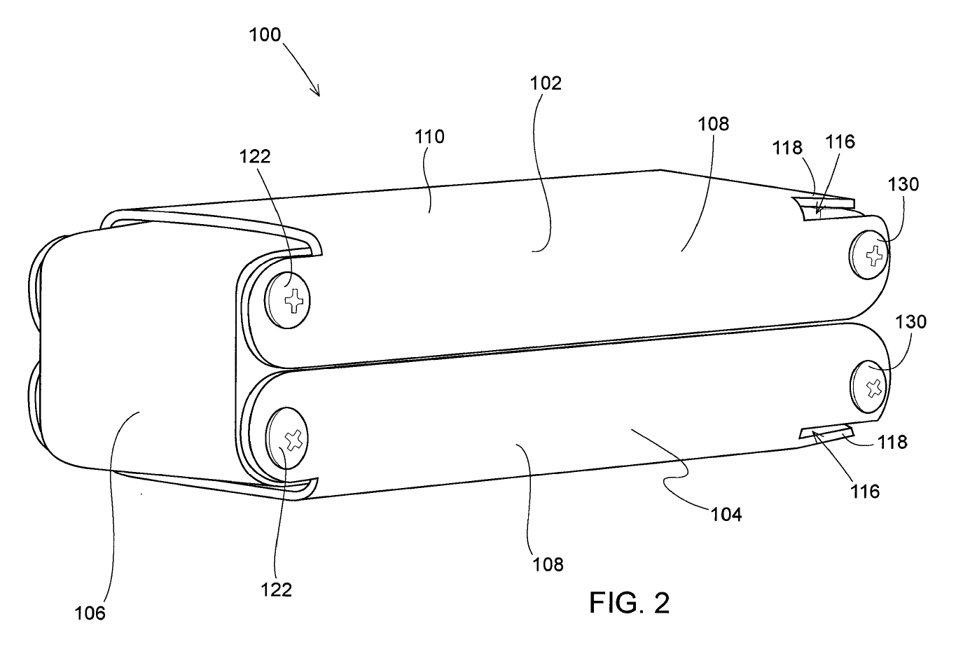

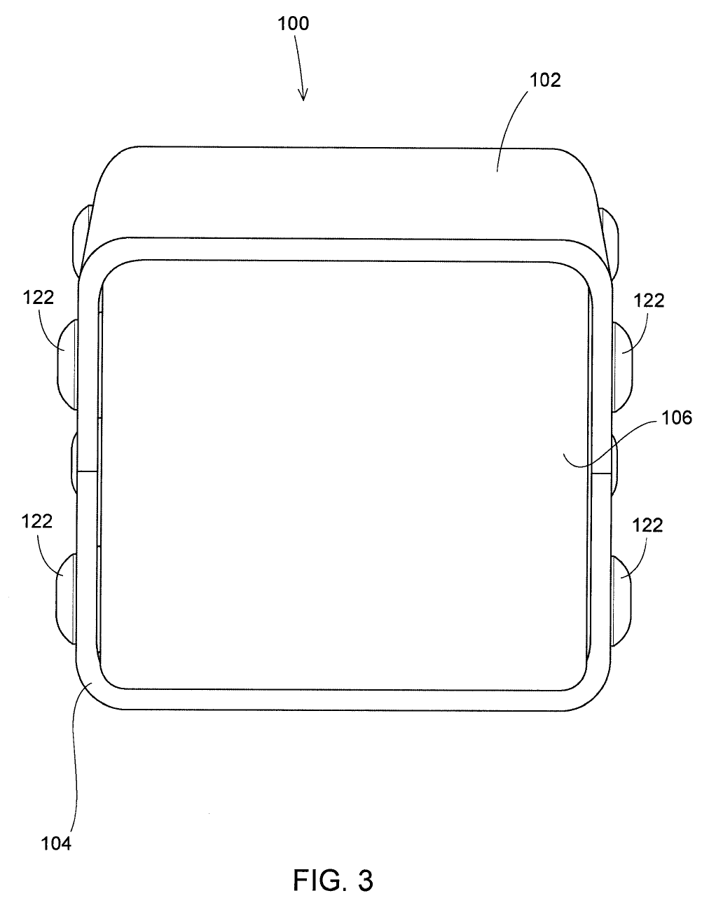

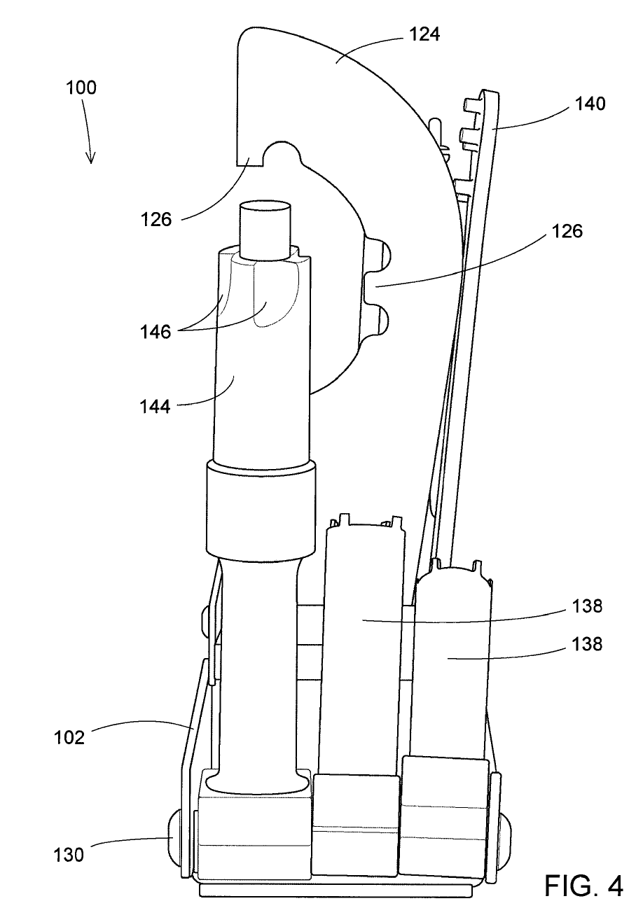

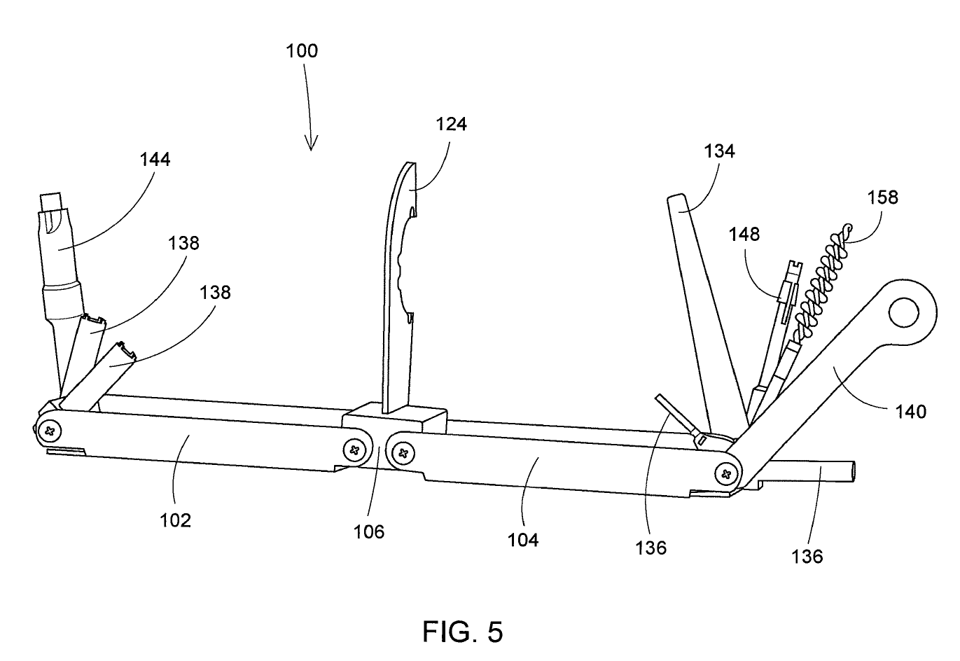

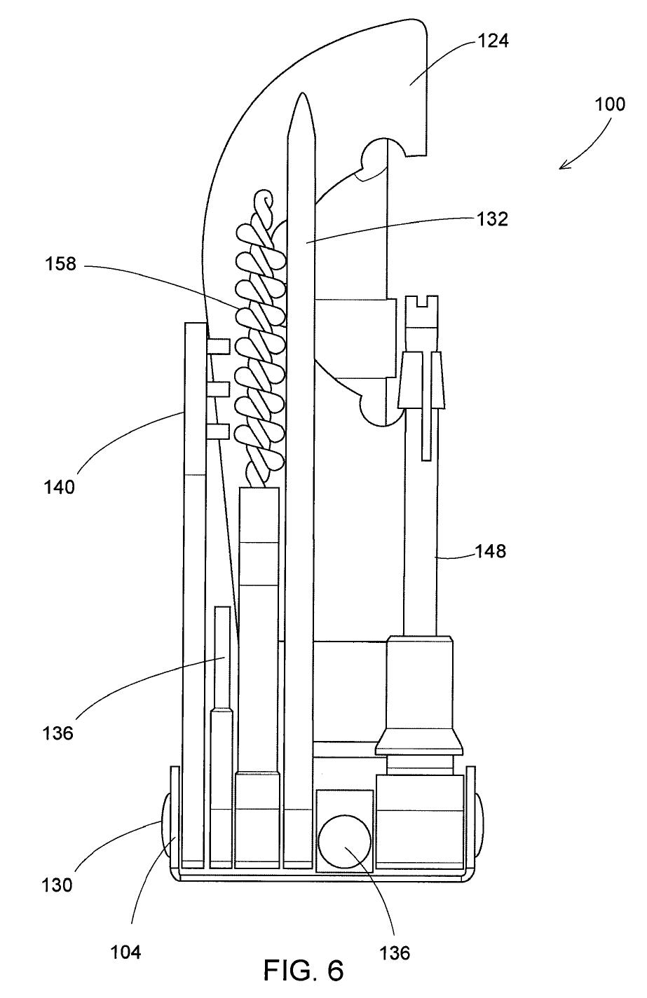

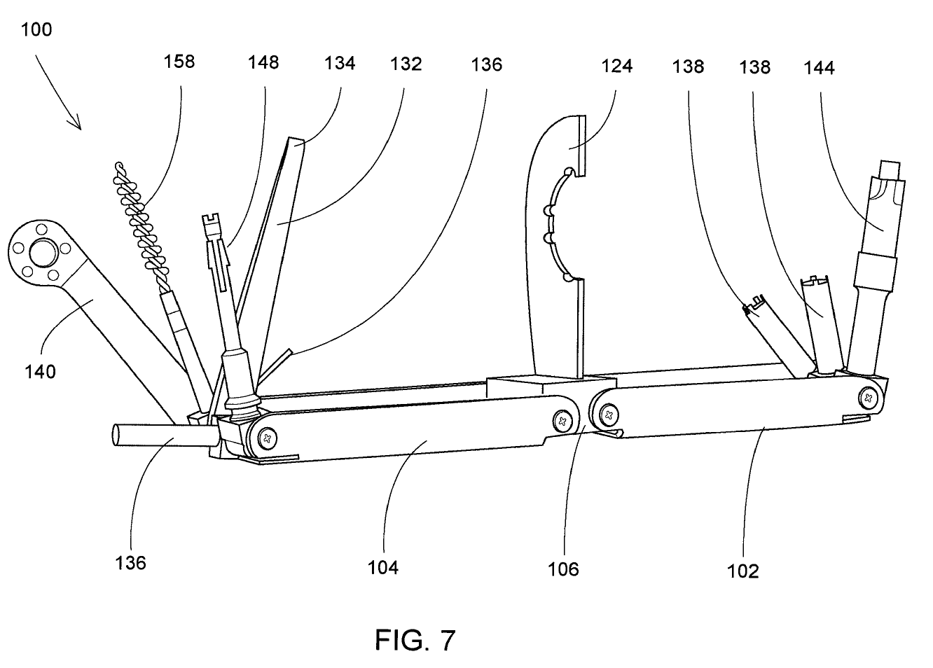

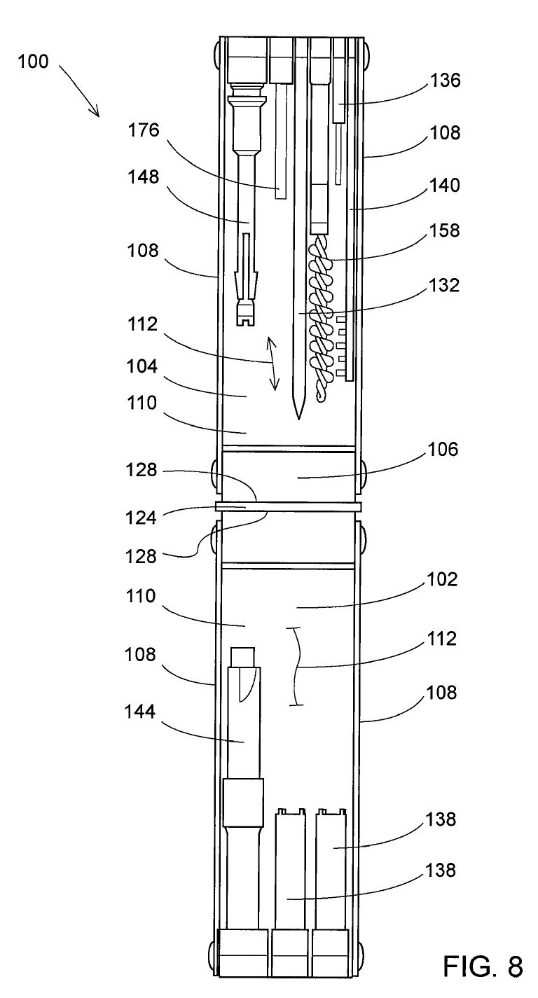

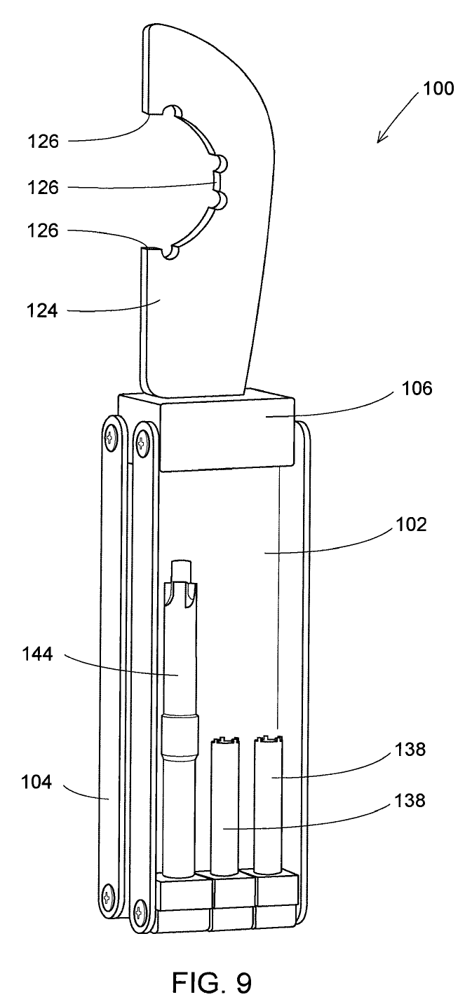

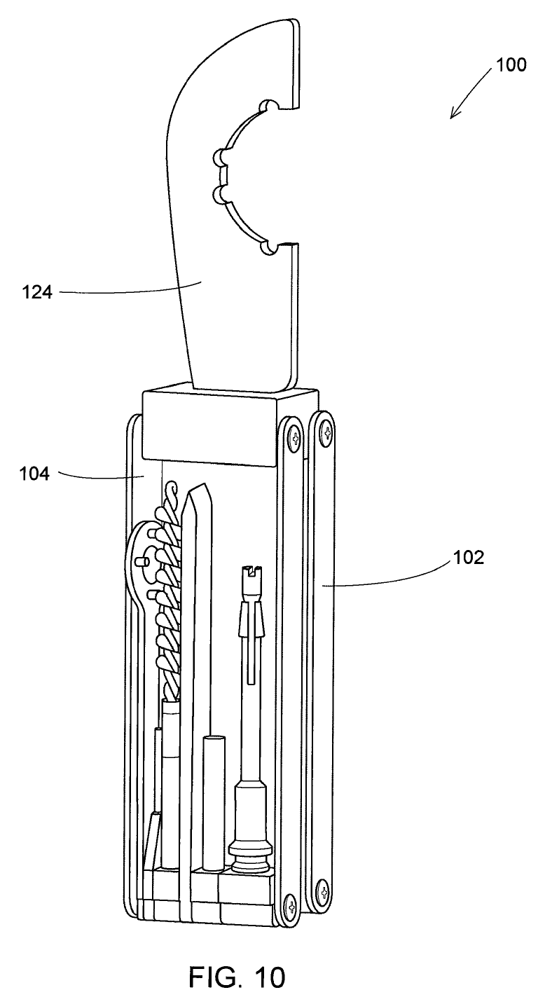

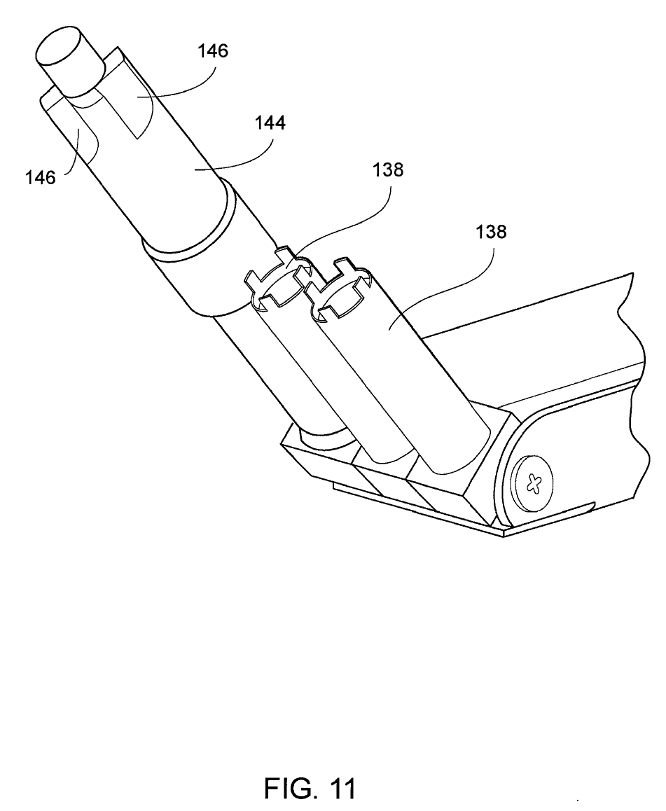

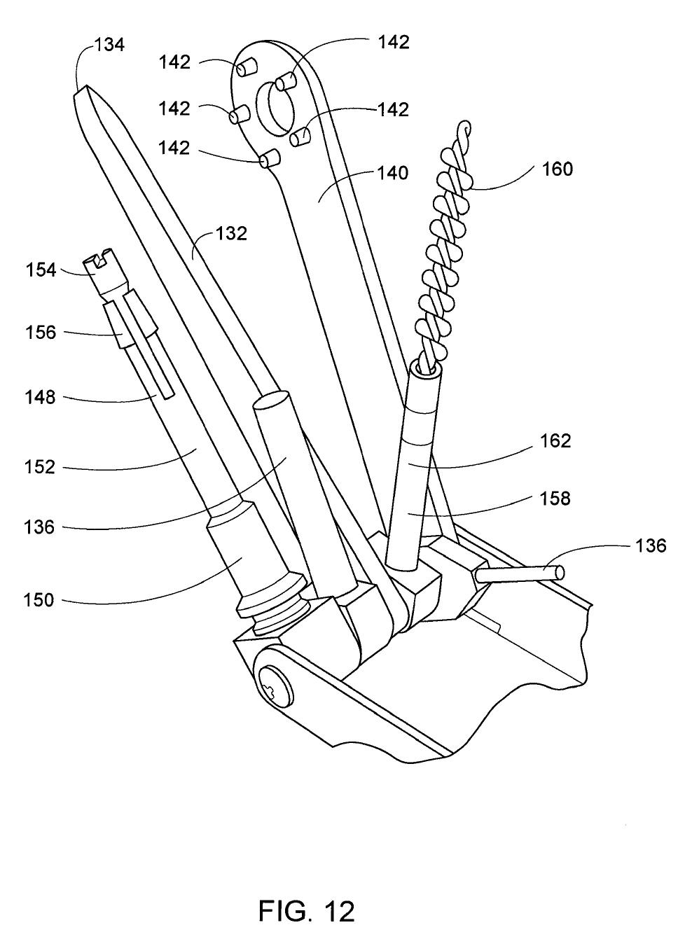

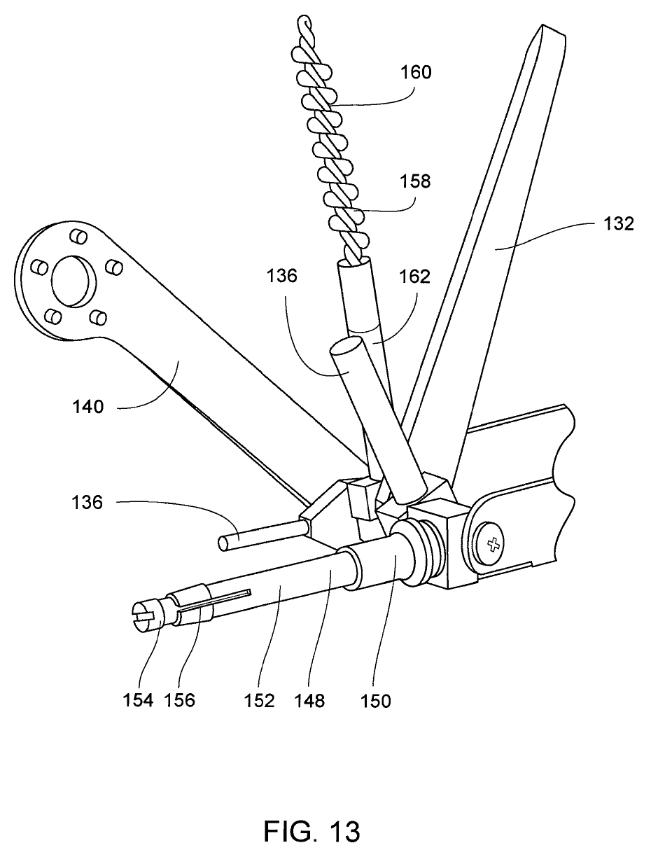

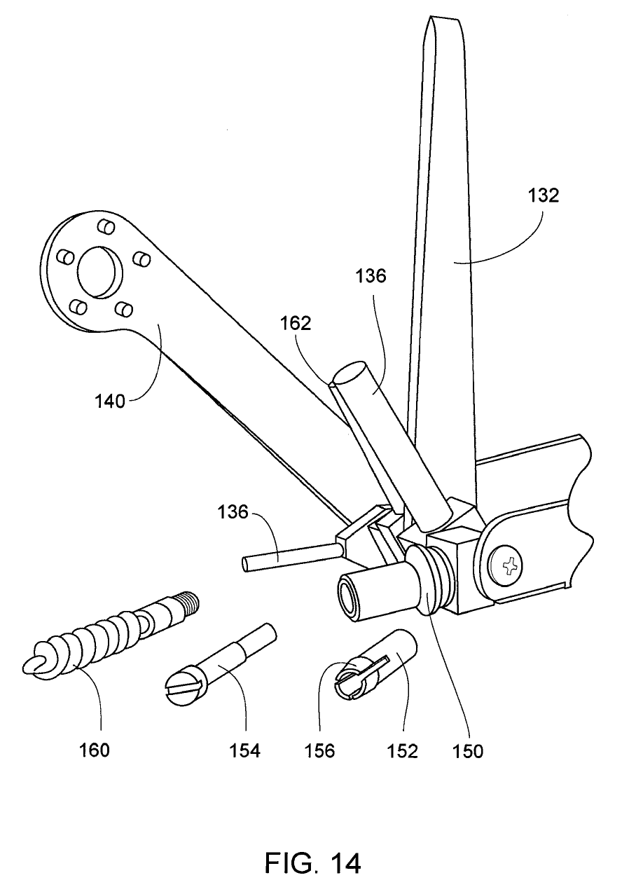

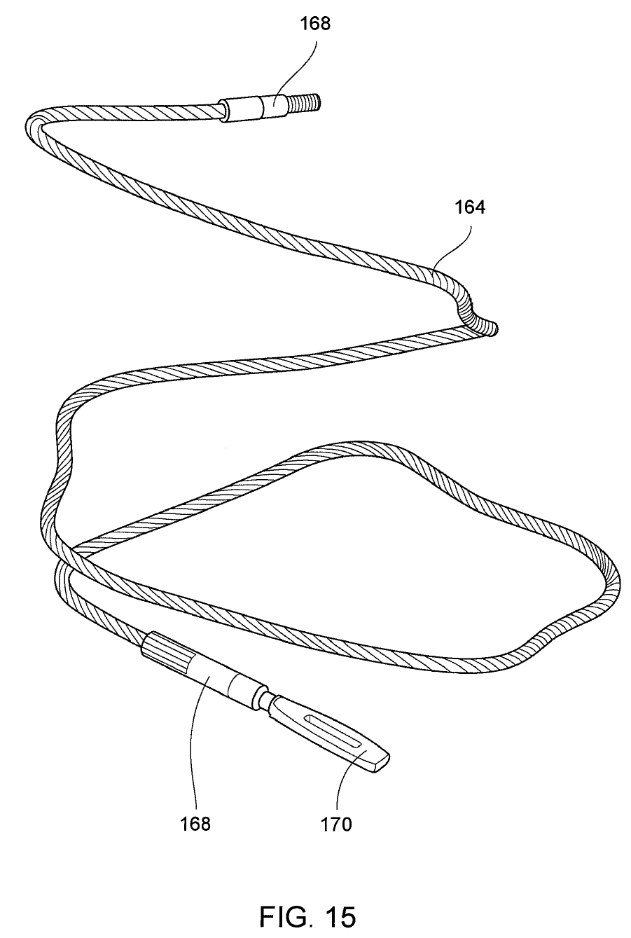

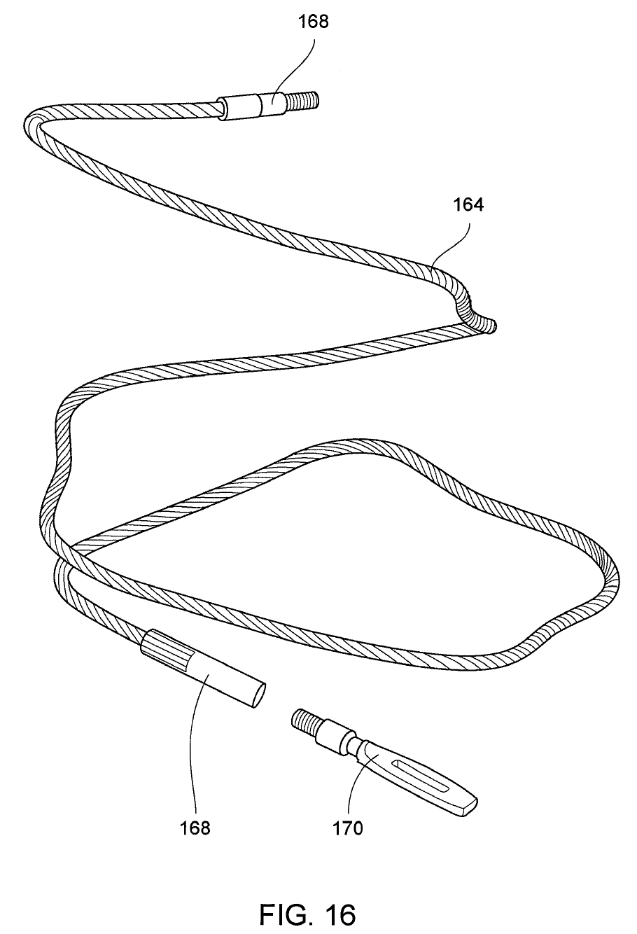

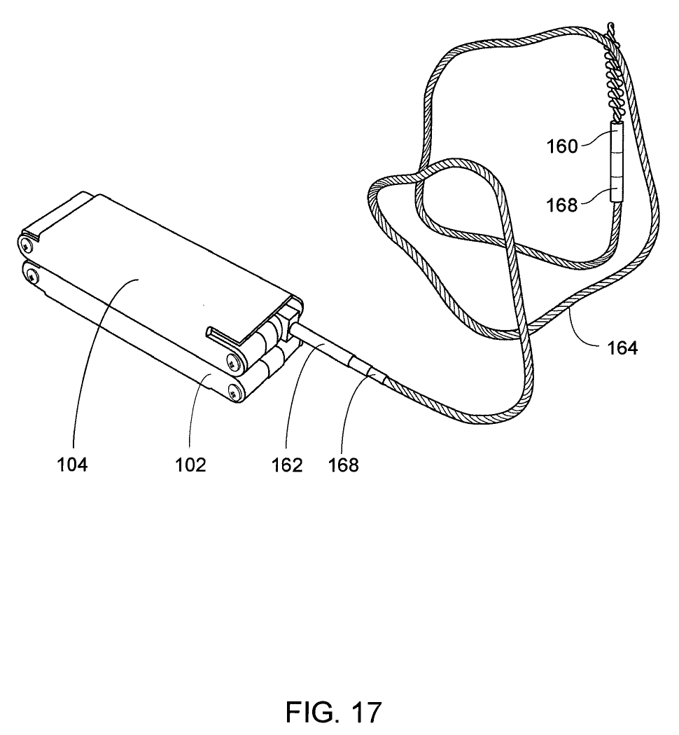

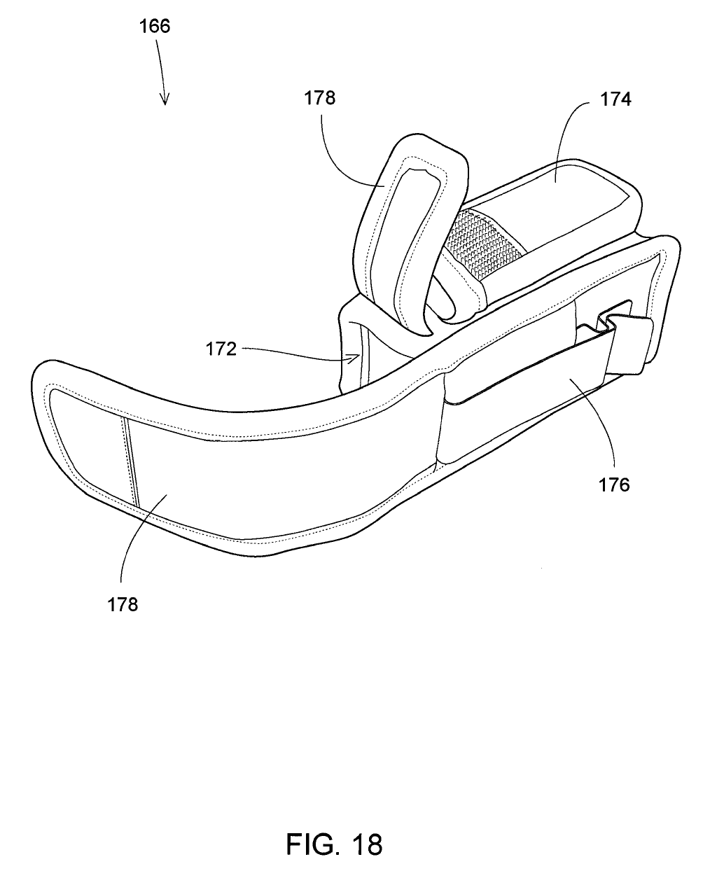

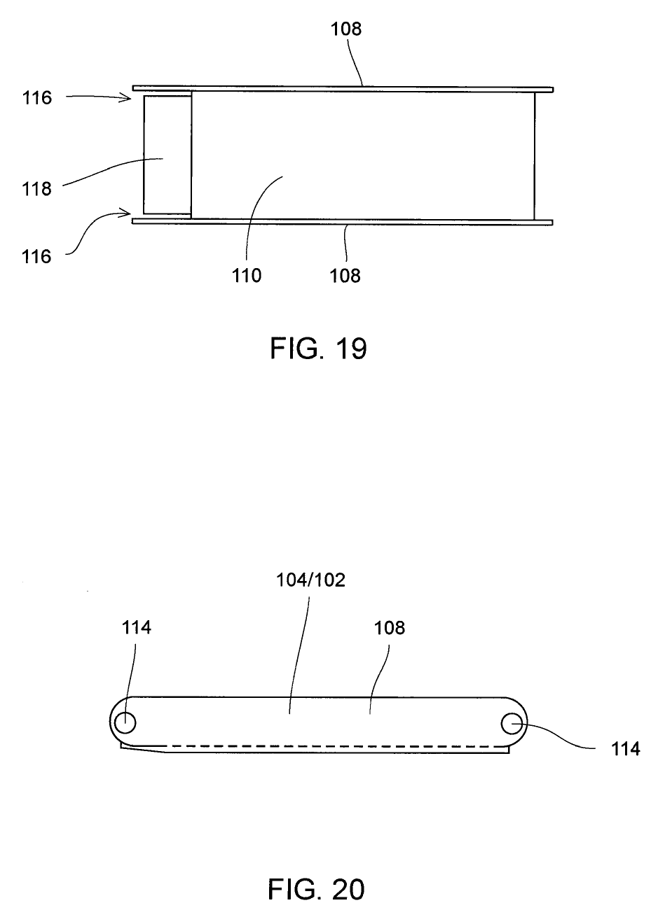

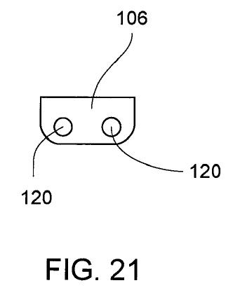

The firearm servicing tool 100 comprises numerous implements for performing various firearm maintenance tasks. A fixed-size (non-adjustable) wrench head 124 is one of such implements. The wrench head 124 is adapted and configured specifically for tightening and loosening a particular size and type of threaded ring, such as the threaded ring that attaches the stock of an M4 automatic rifle to the lower receiver of such firearm. Preferably, the wrench head 124 has a generally semi-circular shape with three gripping tangs 126 oriented ninety degrees apart from each other. The gripping tangs 126 are configured to protrude into notches that are formed into threaded ring in a manner allowing the wrench head 124 to apply torque to the threaded ring. The wrench head 124 is preferably formed of stainless steel sheet or plate material and is preferably rigidly fixed to the hinge piece 106 by such means as welding. Alternatively, the wrench head 124 and hinge piece 106 could be formed as and from a monolithic body. The opposite planar faces 128 of the wrench head 124 are preferably oriented parallel to the through-holes 120 of the hinge piece 106 and the wrench head is preferably centered between the through-holes. The wrench head 124 is dimensioned to fit within the channels 112 of the first 102 and second 106 handle portions. The wrench head 124 protrudes from the hinge piece 106 in a manner such that the wrench head lies within the channels 112 of the first 102 and second 106 handle portions and is surrounded by the handle portions when the tool 100 is in its collapsed position ( as shown in FIGS. 1-3) and such that it extends outwardly from the handle portions when the tool is in its inverted configuration (as shown in FIGS. 9 and 10).

A plurality of other implements for performing various firearm maintenance tasks are pivotally attached to either the first 102 or second 106 handle portions. This is done via pins 130 that extend through the through-holes 114 at the ends of the handle portions opposite the hinge piece 106. Each of such implements is pivotal about the respective pin 130 and is configured to lie within the channels 112 of the first 102 and second 104 handle portions when the tool 100 is in its collapsed position. Additionally, each of such implements has a base, through which the respective pin 130 passes, that is shaped to resiliently deflect the cantilevered portion 118 of the intermediate wall 110 of the respective handle portion as the implement is pivoted to a position where the implement extends outward from the handle portion in a direction directly opposite the hinge piece 106. The resilient deflection of the cantilevered portion 118 of the intermediate wall 110 of the respective handle portion causes the cantilevered portion to bias the implement in said outwardly extending position.

The plurality of other implements includes a screwdriver implement 132 that is adapted to cooperate with slotted screws. The tip 134 of the screwdriver implement is preferably relatively sharp such that the screwdriver implement can also serve as a scraper for removing carbon deposits from firearm components, such as a firearm's bolt. The implements also include cylindrical pin punches 136 of differing diameters which are adapted to facilitate the removal firearm pins, such as a firearm's bolt pin and receiver pin. Additionally, the implements include site adjustment keys 138 adapted and configured to cooperate with the front site adjustment mechanism of particular firearms, such as M-16 and M-4 automatic rifles. Still further, the implements include a rear site wrench 140 that comprises a plurality of parallel cylindrical pins 142 evenly spaced in circle configuration. The rear site wrench 140 is adapted and configured to cooperate with the rear site adjustment mechanism of particular firearms, such as M-16 and M-4 automatic rifles. The implements also include a bolt carrier carbon scraper 144 which has a tip with flutes 146 that have sharp edges. The sharp edges of the flutes 146 are adapted and configured to scrap carbon deposits from the bolt carrier of a firearm by rotating the bolt carrier carbon scraper 144 about its long axis relative to the bolt carrier.

Two of the other implements are preferably removably attached to the firearm servicing tool 100. These include a broken shell extractor tool 148, which preferably comprises a base member 150, a fluted hollow shaft 152, and a screw 154. The fluted hollow shaft 152 preferably comprises a frustoconical taper 156 that is broken or interrupted by the flutes. The screw 154 extends through the fluted hollow shaft 152 and is threadably attached to the base member 150. As the screw 154 is threaded into the base member 150, the screw expands the frustoconical taper 156. The assembly of the base member 150, fluted hollow shaft 152, and screw 154 is preferably removable as a unit from the firearm servicing tool 100 via a connector, such as a threaded fitting (not shown). When removed from the tool 100, the broken shell extractor tool 148 can be inserted into the firing chamber of firearm where it can interlock with a broken or deformed shell in a manner allowing the broken shell extractor tool 148 and the shell to be removed from the firearm. The adjustability of the taper 156 allows the broken shell extractor tool 148 to interlock with various shapes of broken or deformed shells.

The removable implements of the firearm servicing tool 100 also comprise a brush implement 158. The brush implement 158 preferably comprises a conical wire brush portion 160 that is removably connected to a shaft 162. Preferably, female threads on the shaft 162 act as a first connector that cooperates with a second connector (preferably male threads) on the brush portion 160 to releasably secure such components to each other. When the brush portion 160 is secured to the shaft 162, and therefore also to the handle portions of the tool 100, the brush implement 158 is useful for cleaning firearm components such as bolt carrier keys.

A flexible tether 164 and a belt pouch 166 is preferably provided along with the firearm servicing tool 100. The tether 164 is preferably formed of plastic coated braided wire and has opposite ends 168. The opposite ends 168 of the tether comprise connectors, which are preferably thread fittings. A rag pulling fitting 170 is preferably removably connected to one of the connectors of the tether 164. The other of the connectors is adapted and configured to be removably attached to the shaft 162 of the brush implement 158 of the tool 100 when the brush portion 160 is detached therefrom. When the rag pulling fitting 170 is detached from the tether 164, the brush portion 160 of the brush implement 158 can be attached to the tether in place of the rag pulling fitting. The tether 164 facilitates the cleaning of a firearm's barrel. When using the tether 164, the tether is inserted into the bore of a firearm's barrel in a manner such that it extends completely therethrough. The appropriate end 168 of the tether 164 is then attached to the shaft 162 of the brush implement 158 while the other end is attached to the brush portion 160 of the brush implement. A force can then be exerted on the first 102 and second 104 handle portions of the tool 100 in a manner causing tension in the tether 164, which pulls the brush portion 160 of the brush implement 158 through the bore of the firearm. This cleans the bore. In a similar manner, the rag pulling fitting 170 can be used to pull a rag through the bore of the firearm by using the rag pulling fitting in place of the brush portion 160 of the brush implement 158.

The belt pouch 166 serves as a storage container for the tool 100 when the tool is not in use. The belt pouch preferably comprises a large pocket 172, a small pocket 174, and a belt clip 176. The large 172 and small 174 pockets preferably comprise flap closures 178 that are securable in closed positions via interlocking hook and loop material, such as Velcro®. The large pocket 172 is preferably dimensioned to snugly hold the firearm servicing tool 100 therein when the tool is in its collapsed configuration. The small pocket is preferably shaped and dimensioned to snuggly hold the tether 164 and the rag pulling fitting 170. The belt clip 176 is adapted to support the belt pouch from a person's belt.

In view of the foregoing, it will be seen that the several advantages of the invention are achieved and attained.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed.

What is claimed is:

1. A firearm servicing tool comprising:
a hinge piece;
a fixed-size wrench head attached to and fixed in position relative to the hinge piece; first and second handle portions, each of the first and second handle portions being pivotally connected to the hinge piece, the handle portions being movable relative to each other and the wrench head in a manner such that the tool can be selectively reconfigured into at least first and second alternative configurations, the first and second handle portions engaging each other and surrounding the wrench head when the tool is in the first configuration, the first and second handle portions engaging each other with the wrench head extending outwardly therefrom when the tool is in the second configuration.

2. A firearm servicing tool in accordance with claim 1 wherein the first handle portion is pivotally connected to the hinge piece about a first pivot axis, the second handle portion is pivotally connected to the hinge piece about a second pivot axis, and the first and second pivot axes are parallel to and spaced from each other.

3. A firearm servicing tool in accordance with claim 2 wherein each of the first and second handle portions comprises an intermediate wall and two side walls, the intermediate wall joins two side walls, the sides walls of the first handle portion are engaged with the side walls of the second handle portion with the wrench head being positioned between the intermediate walls of the first and second handle portions when the tool is in the first configuration, and the intermediate walls of the first and second handle portions are engaged with each other when the tool is in the second configuration.

4. A firearm servicing tool in accordance with claim 1 wherein a screwdriver implement is pivotally attached to one of the first and second handle portions, the screwdriver implement is positionable between the first and second handle portions when the tool is in the first configuration, and the screwdriver implement is also alternatively positionable in manner such that the screwdriver implement extends outwardly from the respective one of the first and second handle portions when the tool is in the is in the first configuration.

5. A firearm servicing tool in accordance with claim 1 wherein a brush implement is pivotally and removably attached to one of the first and second handle portions, the brush implement is positionable between the first and second handle portions when the tool is in the first configuration, and the screwdriver implement is also positionable in manner such that the screwdriver implement extends outwardly from the respective one of the first and second handle portions when the tool is in the is in the first configuration.

6. A firearm servicing tool in accordance with claim 5 wherein the tool comprises mating threaded connectors that removably attach the brush implement to the respective one of the first and second handle portions.

7. A firearm servicing tool comprising:
a handled body, the handled body comprising first and second handle portions that are movable relative to each other, the handled body also comprising a first connector;
a brush implement, the brush implement comprising a second connector, the brush implement being connectable to the handled body by securing the first and second connectors to each other;
a flexible tether having opposite ends, one of the ends comprising a third connector and the other of the ends comprising a fourth connector, the brush implement being securable in a movable manner to the handled body via the tether by securing the first and third connectors to each other and the fourth and second connectors to each other.

8. A method of servicing a firearm comprising:
utilizing a tool to service the firearm, the firearm comprising a threaded ring, the tool comprising first and second handle portions and a fixed-size wrench head, the first and second handle portions being movable relative to each other and to the wrench head, the utilization of the tool comprising moving the first and second handle portions relative to each other in a manner causing the wrench head to extend outwardly from the first and second handle portions and thereafter using the wrench head to rotate the threaded ring of the firearm.

9. A method of using a tool to service a firearm, the firearm comprising a barrel having a bore, the tool comprising first and second handle portions, a first connector, a flexible tether, and a brush implement, the first and second handle portions being movable relative to each other, the brush implement comprising a second connector that is initially connected to the first connector in manner attaching the brush implement to the first and second handle portions, the tether comprising third and fourth connectors, the method comprising:
moving the first and second handle portions of the tool relative to each other in a manner such that the brush implement can be grasped;
uncoupling the first and second connectors from each other in a manner disconnecting the brush implement from the first and second handle portions;
extending the tether through the bore of the barrel of the firearm;
coupling the third and first connectors to each other in a manner securing the tether to the first and second handle portions after the step of uncoupling the first and second connectors from each other;
coupling the second and fourth connectors to each other in a manner connecting the brush implement to the tether while the tether extends through the bore of the barrel of the firearm;
forcing the first and second handle portions to move away from the barrel of the firearm in a manner causing the tether to pull the brush implement through the bore of the barrel of the firearm.
